(19) United States
(12) Patent Application Publication
(10) Pub. No.: US 2022/0391062 A1
(43) Pub. Date: Dec. 8, 2022

(54) INFORMATION INPUT DEVICE

(71) Applicant: KYOCERA Document Solutions Inc., Osaka (JP)

(72) Inventor: Akira SHIMADA, Osaka-shi (JP)

(73) Assignee: KYOCERA Document Solutions Inc., Osaka (JP)

(21) Appl. No.: 17/805,407

(22) Filed: Jun. 3, 2022

(30) Foreign Application Priority Data
Jun. 4, 2021 (JP) 2021-094218

(51) Int. Cl. G06F 3/0488; G06F 3/0482

(52) U.S. Cl. CPC G06F 3/0488; G06F 3/0482

(57) ABSTRACT

An image forming apparatus includes an information input device. The information input device includes a display section, an operation section, and a controller. The display section sequentially displays a plurality of options. The operation section receives a touch operation operated by a user with his/her foot. The controller performs control of selecting an option, displayed by the display section at a point in time of the touch operation on the operation section, from the plurality of options. For example, the options may be a number from 0 to 9, or a digit contained in a number containing a plurality of digits.

### INCORPORATION BY REFERENCE

The present application claims priority 35 U.S.C. § 119 to Japanese Patent Application No. 2021-094218, filed on Jun. 4, 2021. The contents of this application are incorporated herein by reference in their entirety.

### BACKGROUND

The present disclosure relates to an information input device.

Conventional operation input systems have a touch panel, which receives a piece of security information such as password input by users with their hands.

### SUMMARY

An information input device according to one aspect of the present disclosure includes a display section, an operation section, and a controller. The display section sequentially displays a plurality of options. The operation section receives a touch operation operated by a user with his/her foot. The controller performs control of selecting an option, displayed by the display section at a point in time of the touch operation on the operation section, from the plurality of options.

### BRIEF DESCRIPTION OF THE DRAWINGS

FIG. 1 is a schematic view illustrating an example of a structure of an image forming apparatus including an information input device according to an embodiment.

FIG. 2 is a block diagram illustrating an example of a circuit configuration of the image forming apparatus.

FIG. 3A illustrates an example of display on a first touch panel, and FIG. 3B illustrates an example of display on a second touch panel.

FIG. 4A illustrates another example of display on the first touch panel, and FIG. 4B illustrates another example of display on the second touch panel.

FIG. 5 illustrates still another example of display on the first touch panel.

### DETAILED DESCRIPTION

The following describes an embodiment of the present disclosure with reference to the drawings. In the drawings, like elements will be indicated using like reference signs and descriptions thereof are not repeated.

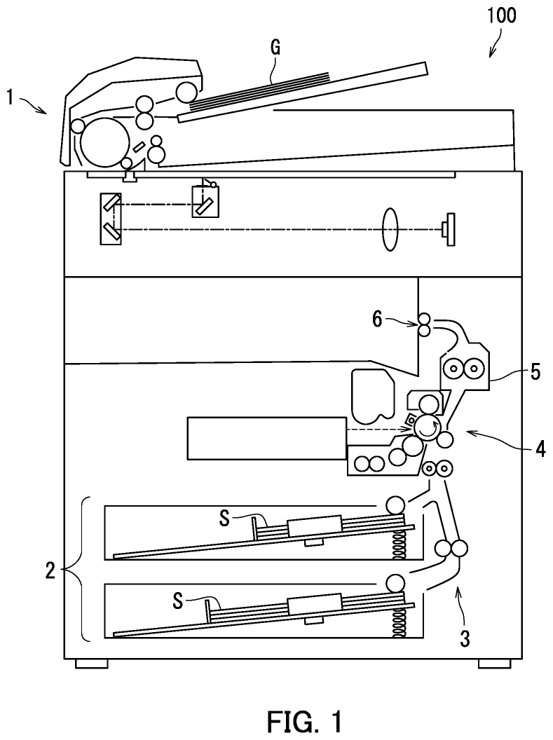

An image forming apparatus 100 including an information input device according to an embodiment will now be described with reference to FIG. 1. FIG. 1 is a schematic view illustrating an example of a structure of the image forming apparatus 100. The image forming apparatus 100 may be a copier, a printer, a facsimile machine, or a multifunction peripheral having these functions, for example.

As illustrated in FIG. 1, the image forming apparatus 100 includes a reading section 1, feeding sections 2, conveyance sections 3, an image forming section 4, a fixing section 5, and an ejection section 6.

The reading section 1 reads an image of a document G and generates image data from the read image. The feeding section 2 accommodates a plurality of sheets S, and feeds the sheet S to the conveyance section 3. The sheet S is made from, for example, paper or synthetic resin. The conveyance section 3 includes a plurality of conveyance roller pairs, and conveys the sheet S to the image forming section 4.

The image forming section 4 electrophotographically forms a toner image on the sheet S. The image forming section 4 includes a photosensitive drum, a charging device, a light exposure device, a development device, a replenishment device, a transfer device, a cleaning device, and a static elimination device. The replenishment device replenishes the development device with a toner, which is a consumable goods.

The fixing section 5 applies heat and pressure to the toner image to fix the toner image on the sheet S. The conveyance section 3 conveys, to the ejection section 6, the sheet S on which the toner image has been fixed. The ejection section 6 ejects the sheet S out of the image forming apparatus 100.

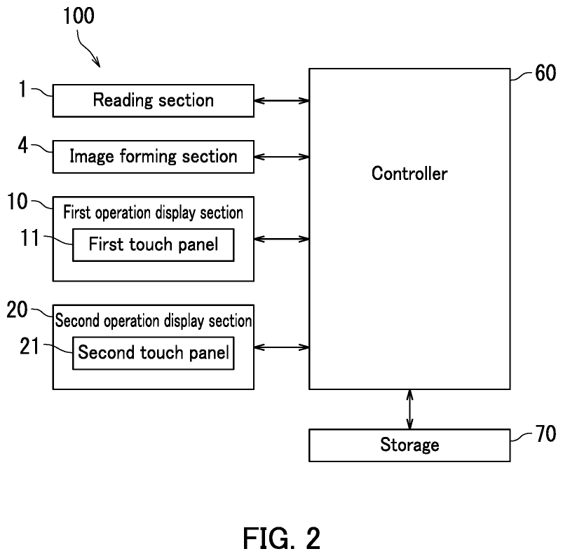

The following describes a circuit configuration of the image forming apparatus 100 with reference to FIGS. 1 and 2. FIG. 2 is a block diagram illustrating an example of the circuit configuration of the image forming apparatus 100.

As illustrated in FIG. 2, the image forming apparatus 100 further includes a first operation display section 10, a second operation display section 20, a controller 60, and storage 70.

The first operation display section 10 serves as an input device for various user operations and a display device displaying a message to the user. The first operation display section 10 is arranged at a position where the user can operate it by hand. The first operation display section 10 includes, for example, a first touch panel 11, and a plurality of push buttons. The first touch panel 11 sequentially displays a plurality of options. Moreover, the first touch panel 11 is designed to be hidden from anyone other than the user who is operating the first touch panel 11. The first operation display section 10 is an example of the “display section”.

The second operation display section 20 serves as an input device receiving touch operations operated by the user with his/her foot and a display device displaying a message to the user. The second operation display section 20 is arranged at a position where the user can operate it with his/her foot. The second operation display section 20 includes a second touch panel 21, for example. The second operation display section 20 is an example of the “operation section”.

The storage 70 includes a storage device and stores data and computer programs. The storage 70 includes a main storage device such as semiconductor memory and an auxiliary storage device such as a hard disk drive (HDD).

The controller 60 includes a processor such as a central processing unit (CPU), and controls each elements of the image forming apparatus 100 by executing a computer program stored in the storage 70. Specifically, the controller 60 controls each operation of the reading section 1, the image forming section 4, the first operation display section 10 and the second operation display section 20.

In particular, the controller 60 performs control of selecting an option, displayed by the first operation display section 10 at a point in time of the touch operation by the users foot on the second operation display section 20, from the plurality of options sequentially displayed by the first operation display section 10.

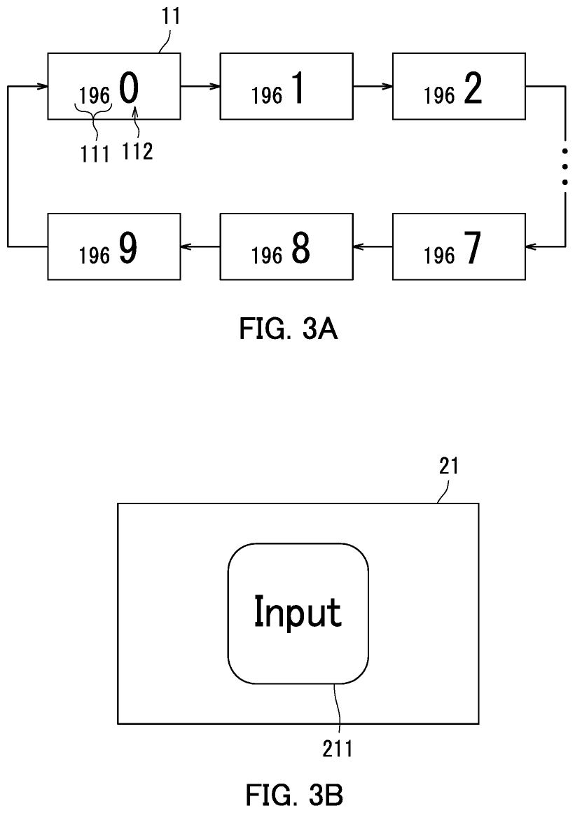

An operation of the controller 60 that receives an input of a password containing four digits will now be described with reference to FIGS. 3A and 3B. FIG. 3A illustrates an example of display on the first touch panel 11, and FIG. 3B illustrates an example of display on the second touch panel 21.

The user intends to input a password containing four digits “1962”. The user has input the upper three digits “196” and is about to input the last digit “2”. As illustrated in FIG. 3A, the first touch panel 11 displays an already-input portion 111 in a small font, and a current-input portion 112 in a large font. The already-input portion 111 does not change, but the current-input portion 112 changes sequentially from 0 to 9 as an option.

As illustrated in FIG. 3B, the second touch panel 21 displays an input button 211. The user who wants to input the last digit “2” of the password touches the input button 211 with his/her foot at the timing when the first touch panel 11 displays “2” on the current-input portion 112. In response to the touch operation, the controller 60 performs control of selecting “2” as the last digit of the password from 0 to 9. As a result, the user can input the password without touching the first touch panel 11, while keeping the password secure.

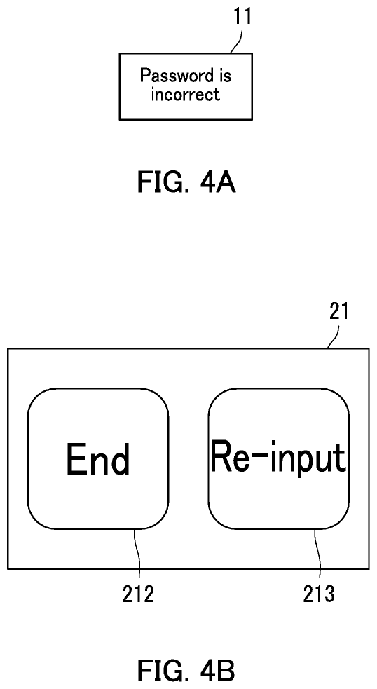

An operation of the controller 60 that receives a correction input of the password will now be described with reference to FIGS. 4A and 4B. FIG. 4A illustrates another example of display on the first touch panel 11, and FIG. 4B illustrates another example of display on the second touch panel 21.

As illustrated in FIG. 4A, the first touch panel 11 displays the message “Password is incorrect”. As illustrated in FIG. 4B, the second touch panel 21 displays a plurality of foot operated options including an end button 212 and a re-input button 213. When the user touches the end button 212 with his/her foot, the controller 60 performs control of prohibiting the re-input of the password. When the user touches the re-input button 213 with his/her foot, the controller 60 performs control of re-inputting the password. That is, the controller 60 performs control of selecting a foot operated option, according to a position of the touch operation on the second touch panel 21, from the plurality of foot operated options. As a result, the user can correct the password without touching the first touch panel 11, while keeping the password secure.

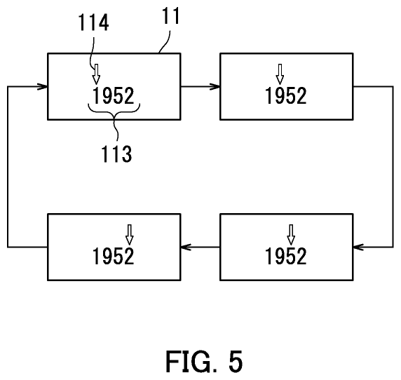

The following describes another operation of the controller 60 that receives the correction input of the password with reference to FIG. 5. FIG. 5 illustrates still another example of display on the first touch panel 11.

The user intends to correct the entered four-digit password “1952” to “1962”. As illustrated in FIG. 5, the first touch panel 11 displays an already-input portion 113 containing the four digits “1952” and a cursor 114 indicating the digit position of each of the four digits “1952”. The already-input portion 113 does not change, but the digit position indicated by the cursor 114 changes sequentially as an option. The user who wants to correct the third number “5” from the left of the password touches the input button 211 shown in FIG. 3B with his/her foot at the timing when the cursor 114 indicating the third digit “5” from the left on the first touch panel 11. In response to the touch operation, the controller 60 performs control of selecting the third digit from the left at which the cursor 114 indicated as the correction digit position of the password. The display on the first touch panel 11 transitions to display for password input according to the manner illustrated in FIG. 3A. As a result, the user can correct the password without touching the first touch panel 11, while keeping the password secure.

According to the embodiment, an image forming apparatus 100 having an information input device effective for infectious disease control is provided.

An embodiment of the present disclosure has been described above with reference to the accompanying drawings. However, the present disclosure is not limited to the above embodiment and can be implemented in various manners within a scope not departing from the gist thereof. Also, a plurality of elements of configuration disclosed in the foregoing embodiments can be combined as appropriate to form various disclosures. For example, some of the elements of configuration disclosed in the embodiments may be omitted. The drawings mainly illustrate various constituent elements schematically for ease of understanding. Aspects such as numbers of the constituent elements illustrated in the drawings may differ in practice for convenience of drawing preparation. Furthermore, the constituent elements illustrated in the above embodiment are one example and not particular limitations.

Application of the information input device according to the present disclosure is not limited to the image forming apparatus 100 in the embodiment, and may be applied in an automated teller machine (ATM), for example.

What is claimed is:

1. An information input device, comprising:
a display section configured to sequentially display a plurality of options,
an operation section configured to receive a touch operation operated by a user with his/her foot,
a controller configured to perform control of selecting an option, displayed by the display section at a point in time of the touch operation on the operation section, from the plurality of options.

2. The information input device according to claim 1, wherein,
each of the plurality of options is any one of numbers from 0 to 9.

3. The information input device according to claim 1, wherein,
each of the plurality of options is any one of digits contained in a number containing a plurality of digits.

4. The information input device according to claim 1, wherein,
the operation section includes a touch panel displaying a plurality of foot operated options in parallel,
the controller further has a function that performs control of selecting a foot operated option, according to a position of the touch operation on the touch panel, from the plurality of foot operated options.
